(19) United States
(12) Patent Application Publication
(10) Pub. No.: US 2012/0314896 A1
(43) Pub. Date: Dec. 13, 2012

(54) Retractable Audio Cord Device

(76) Inventor: Kevin Bryant, New York, NY (US)

(21) Appl. No.: 13/154,580

(22) Filed: Jun. 7, 2011

(51) Int. Cl. H04R 1/10

(52) U.S. Cl. 381/380

(57) ABSTRACT

A retractable audio cord device comprising a housing to contain a plurality of internal components; a retraction button attached to the surface of the housing, where the retraction button activates a spool within the housing; a set of receivers around an edge of the housing, where the set of receivers enable a set of cords to extend and retract from the housing; a pair of earphone cords extending from the set of receivers, where the pair of earphone cords retract into the housing and wraps around the spool when the retraction button is pressed; a pair of earbuds attached to the earphone cords; a connection cord extending from the set of receivers, where the connection cord retracts into the housing and wraps around the spool when the retraction button is pressed and where the connection cord includes a connector to attach the retractable audio cord device to an audio device.

### BACKGROUND OF THE INVENTION

1. Field of the Invention

The present invention relates to an earphone device that is stored within a compact case wherein the compact case retracts a set of accessory cords when the earphones are not in use.

2. Description of Related Art

Portable audio devices are common accessories used by individuals of almost any age. The portable audio devices may be easily carried or worn attached to a user's body or belongings. For example the portable audio device may be worn in an arm cuff or clipped to their belt to free the user's hands thereby allowing them to perform other tasks. A component typical of all portable audio devices is the earphones and cords necessary to listen to the music or sounds coming from the device. As most earphone users have experienced the cords often get tangled or knotted both during and after use. Either due to movement while transporting the audio device or shuffling during storage, earphone users spend unnecessary amounts of time detangling and straightening their earphone cords between uses. This action may become tedious, time consuming and frustrating after repeated attempts.

Some devices have been developed to assist the user when organizing their earphone cords. For example, U.S. Pat. No. 7,610,661 by Barry Sween et. al. discloses a cord management device, wherein a figure eight shaped body member enables a user to wrap their earphone cords around the body during use. The ends of the body member include slits to lock the cords so that they don't unravel during transport. A problem with the body member is that the cord may easily slide out of the slits and create a greater knot by including the body member into the mess. Alternatively, U.S. Pat. No. 6,616,080 by Bruce Philip Edwards et. al. discloses a retractable cord device wherein a housing includes a rewinding spool to pull the cord of a earphone typically used with a cellular phone. The housing and rewinding spool organize the earphone cord to ensure that the cord does not become tangled. While this device includes a rewind feature the device is designed for use with a single cord of a cellular phone earpiece rather than the double cords common to most audio devices.

Therefore it would be beneficial in the art to provide a retraction housing to contain the cords for a pair of earphones and the connection cord. It would also be desirable in the art to provide a housing that includes a feature to quickly and easily retract the cords when not in use.

### SUMMARY OF THE INVENTION

In view of the foregoing disadvantages inherent in the prior art, the general purpose of the present invention is to provide a retractable audio cord device, configured to include all of the advantages of the prior art, and to overcome the drawbacks inherent therein.

Accordingly, an object of the present invention is to provide a retractable audio cord device wherein a housing refracts a pair of earphone cords and a connection cord as desired by the user.

Another object of the present invention is to provide a button on the housing that activates an internal retraction spool to quickly and easily pull the cords inside the housing.

To achieve the above objects, in an aspect of the present invention, a retractable audio cord device is disclosed comprising a housing to contain a plurality of internal components; a retraction button attached to an outer surface of the housing, where the retraction button activates a refraction spool within the housing; a set of receivers around an edge of the housing, where the set of receivers enable a set of cords to extend and retract from the housing; a pair of earphone cords extending from the set of receivers, where the pair of earphone cords retract into the housing and wraps around the refraction spool when the retraction button is pressed; a pair of earbuds attached to the earphone cords; a connection cord extending from the set of receivers, where the connection cord retracts into the housing and wraps around the retraction spool when the retraction button is pressed and where the connection cord includes a connector to attach the retractable audio cord device to an audio device.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a retractable audio cord device in accordance with an exemplary embodiment of the preset invention;

FIG. 2 depicts a perspective view of a retractable audio cord device in an extended position in accordance with an exemplary embodiment of the present invention; and

FIG. 3 depicts a perspective view of an ear wrap earphone in accordance with an alternative embodiment of the present invention.

Like reference numerals refer to like parts throughout the description of several views of the drawings.

### DETAILED DESCRIPTION OF THE DRAWINGS

The present invention relates to an earphone device that is stored within a compact case wherein the compact case retracts a set of accessory cords when the earphones are not in use. The present invention provides a retractable audio cord device as a way to protect and store a pair of earphones. The retractable audio cord device comprises a housing with an internal retraction spool which pulls the cords into the housing when the retractable audio cord device is not in use. The earphones may exchange between a pair of earbuds which gently insert into the user's ears or a pair of ear wrap earphones which insert and then hang from the user's ear. Because of the compact design and retraction feature the retractable audio cord device is easily stored in a user's pocket, purse, bag, desk and the like.

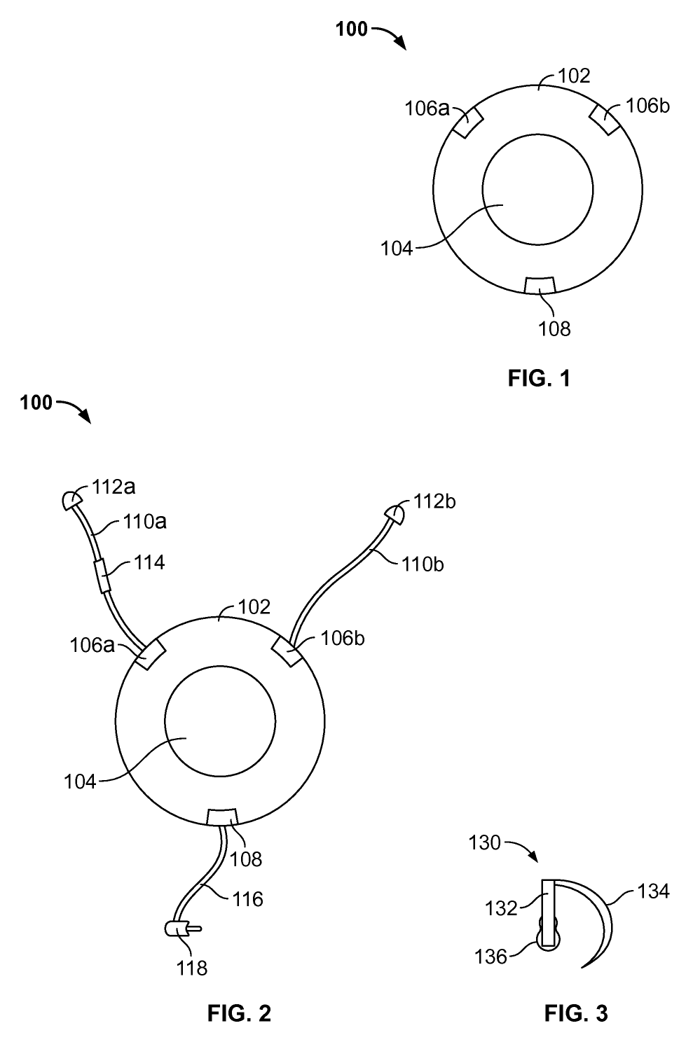

Tuning now descriptively to the drawings, referring to FIG. 1, a perspective view of a retractable audio cord device (100) is shown in accordance with an exemplary embodiment of the present invention. The retractable audio cord device (100) includes a housing (102) to contain the internal components of the retractable audio cord device (100). The housing (102) may be made from a durable fabric like canvas or a lightweight plastic material or aluminum for easy transport and storage. Fastened to a central portion on an outer surface of the housing (102) is a retraction button (104). The retraction button (104) activates a retraction spool within the housing (102) which in turn retracts a set of cords associated with the retractable audio cord device (100). On the backside of the housing (102), opposite to where the retraction button (104) is attached, may be a clip (not shown). The clip enables the user to fasten the retractable audio cord device (100) to their waist, belt, purse, bag, strap or the like.

Positioned to a circumferential edge of the housing (102) are a set of receivers (hereinafter receivers), a pair of earphone receivers (106a, 106b) (hereinafter earphone receivers) and a connection cord receiver (108). The receivers (106a, 106b, 108) provide an opening for the plurality of cords to extend and retract from the housing (102). The pair of earphone receivers (106a, 106b) may be positioned closer to each other to accommodate the cords used for the earphones. The connection cord receiver (108) may be positioned at a lower portion of the housing (102) to enable a connection cord to easily extend and retract from the housing (102) as desired.

Referring now to FIG. 2 a perspective view of a retractable audio cord device (100) is shown in an extended position in accordance with an exemplary embodiment of the present invention. From the earphone receivers (106a, 106b) a pair of earphone cords (110a, 110b) (hereinafter earphone cords) may extend. The earphone cords (110a, 110b) easily extend when pulled by the user and then retract into the housing (102) when the retraction button (104) is pressed. At the ends of the earphone cords are a pair of earbuds (112a, 112b) (hereinafter earbuds). The earbuds (112a, 112b) are placed within the user's ears so that they may listen to the audio device attached to the retractable audio cord device (100). Attached to one of the earphone cords (110a) may be a controller (114). The controller (114) may activate and control the volume of the noise received into the earbuds (112a, 112b).

The connection cord receiver (108) enables a connection cord (116) to extend and retract from the retraction spool within the housing (102). At the end of the connection cord (116) is a connector (118). The connector (118) inserts into the audio device to enable the user to listen to the device through the earbuds (112a, 112b). The audio device may be an iPod®, MP3 player, radio player, cellular phone, smartphone, computer or any other audio device commonly used with earphones. FIG. 2 illustrates the retractable audio cord device (100) in the extended position wherein the earphone cords (110a, 110b) and the connection cord (116) are extended from the housing (102) to be easily accessible for use. During storage or transport all of the cords are retracted into the housing to ensure that they do not tangle or knot between uses.

Referring to FIG. 3 a perspective view of an ear wrap earphone (130) is shown in accordance with an alternative embodiment of the present invention. The ear wrap earphone (130) may replace or be exchanged with the earbuds (112a, 112b) at the ends of the earphone cords (110a, 110b). The ear wrap earphone (130) includes a body member (132) positioned in a central portion of the ear wrap (130). From the body member (132) is an ear hanger (134) that extends in a circular fashion from the top of the body member (132). The ear hanger (134) may be covered with a soft material like rubber or fabric for a comfortable fit against the user's ear. Attached to an opposing portion of the body member (132) from the ear hanger (134) is an earbud (136). During use, the ear hanger (134) wraps behind the user's ear while the earbud (136) is placed within the ear. The ear hanger (134) provides additional security to ensure that the ear wrap earphone (130) does not fall out of the user's ear in cause the user moves their head or the earphone cords (110a, 110b) are pulled or bumped.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A retractable audio cord device comprising:
a housing to contain a plurality of internal components;
a retraction button attached to an outer surface of said housing, where said retraction button activates a retraction spool within said housing;
a set of receivers around a circumferential edge of said housing, where said receivers enables a set of cords to extend and retract from said housing;
a pair of earphone cords extending from said set of receivers, where said pair of earphone cords retract into said housing and wraps around said retraction spool when said retraction button is pressed;
a pair of earbuds attached to said earphone cords, where said pair of earbuds are inserted into a pair of ears of a user during use; and
a connection cord extending from said set of receivers, where said connection cord retracts into said housing and wraps around said retraction spool when said retraction button is pressed and where said connection cord includes a connector to attach said retractable audio cord device to an audio device.

2. The retractable audio cord device according to claim 1, wherein said earbuds are attached an ear wrap earphone, where said ear wrap earphone includes a body member attached to an ear hanger to wrap said ear wrap earphone over said pair of ears.

3. The retractable audio cord device according to claim 4, wherein said ear hanger is covered with a soft material to protect said pair of ears during use.

4. The retractable audio cord device according to claim 1, wherein said housing is made from one of at least fabric, aluminum, and plastic.

5. The retractable audio cord device according to claim 1, wherein one of said pair of earphone cords includes a controller to control the volume received by said pair of earbuds.

6. The retractable audio cord device according to claim 1, wherein on a backside of said housing is a clip to attach said housing to one of at least a waist, belt, purse, bag and strap.
